(19) United States
(12) Patent Application Publication
(10) Pub. No.: US 2019/0086368 A1
(43) Pub. Date: Mar. 21, 2019

(54) Pipe Inspection Tool with Stationary Contact Platform Assembly

(71) Applicant: Baker Hughes, a GE company, LLC, Houston, TX (US)

(72) Inventors: Peter Plichta, Calgary (CA); Mikhail Anisimov, Calgary (CA); McKenzie R. Kissel, Calgary (CA)

(73) Assignee: Baker Hughes, a GE company, LLC, Houston, TX (US)

(21) Appl. No.: 15/708,946

(22) Filed: Sep. 19, 2017

(51) Int. Cl. G01N 29/22; G01N 29/04; G01N 27/04

(52) U.S. Cl. CPC G01N 29/225; G01N 2291/262; G01N 27/041; G01N 29/04

(57) ABSTRACT

Pipe inspection tools have a central shaft assembly with one or more stationary contact platform assemblies which extend radially outwardly therefrom. Each stationary contact platform assembly includes a platform which is moveable radially inward and outward sequentially to create periodic contact with a pipe wall and an axially moveable contact cart which maintains stationary contact over a period of time in which the platform is in the radially outward position.

### BACKGROUND OF THE INVENTION

### 1. Field of the Invention

The invention relates generally to the design of in-line pipe inspection tools.

### 2. Description of the Related Art

Pipelines often carry liquids and gases under high pressure. The carried liquids and gases may contain solids or corrosives which can damage the pipeline. Thus, it has become increasingly important to monitor the interior surfaces of pipelines to be able to correct physical damage, corrosion, rust, contamination or other problems.

In-line pipe inspection tools are used to examine the interior surfaces of pipelines to ensure their integrity. One variety of in-line pipe inspection tool is commonly referred to as a pig. Pigs travel within the pipeline under pressure. Many contemporary in-line inspection tools contain on-board sensors and data recording equipment. As a result, they are often referred to as “smart” pigs.

One type of in-line inspection tool is a tool that measures the voltage differential along the inner surface of the pipe. The tool provides a measure of the effectiveness of applied corrosion protection for a pipeline and the need for corrective actions to be taken to prevent problematic corrosion. The tool measures a voltage drop across a short distance of the pipeline. To do this, the tool provides two distinct electrical contact points with the pipeline wall which are separated by a known distance. The measured voltage drop is then used to calculate the DC current and current density.

Current designs for these tools incorporate either rotating steel knives or, more typically, bare steel rotary brushes to form the electrical contact points. The brushes are intended to slide or roll along the interior surface of the pipeline as the tool moves through the pipeline under the impetus of pressurized fluid. Contact between the brushes is intermittent because the contact point moves constantly as the tool moves through the surrounding pipe. Additionally, the contact points are subject to vibration during operation which leads to variability in contact pressure and increased undesirable friction and temperature. In dry gas environments, these effects become even worse as compared to liquid pipelines. Increased dynamics at the contact surfaces (bristles) introduce background noise even where there is perfect electrical contact with the surface of the pipe.

### SUMMARY OF THE INVENTION

The invention provides pipe inspection tools having an improved design for contacting a pipeline wall and yielding improved data relating to the condition of the pipeline. Pipe inspection tools are described which provide for stationary, non-sliding contact between a contact cart and the interior surface of the pipeline for a period of time even as the tool continues to move axially through the surrounding pipe. The described tool design provides for increased time for obtaining measurement of one or more pipe condition parameters at the pipe wall and yielding more accurate data. In some embodiments, the pipe condition parameter is a voltage differential measurement. In other embodiments, the pipe condition parameter is a hardness, acoustic, ultrasonic or other property which is measured by a sensor.

Exemplary pipe inspection tools are described which include a central shaft assembly which preferably carries several flexible shaped cups designed to capture fluid to move the tools through a pipe along with fluid within the pipe. One or more stationary contact platform assemblies are supported by a support arm at a position that is radially outward from the shaft assembly. Each stationary contact platform assembly includes a carriage, a platform which is moveable radially outwardly and inwardly with respect to the carriage, and a contact cart which is moveable axially upon the platform between forward and rearward positions. The contact cart carries either an electrical contact or a sensor which is useful for detecting or measuring a pipe condition parameter.

In one described embodiment, a pipe inspection tool carries multiple stationary contract platform assemblies in the form of electrical contact platform assemblies. At least one first electrical contact platform assembly and at least one second electrical contact platform assembly are carried by the central shaft assembly. If differential measurement is taken to measure a pipe condition parameter, sets, or at least one, of each of the first and second electrical contact platform assemblies are spaced apart from one another upon the shaft assembly by a predetermined distance. The contact carts of the electrical contact platform assemblies have electrically conductive elements which make electrical contact with the interior wall of the pipe when the contact cart is brought into contact with the interior wall. The described inspection tool also includes a voltage measurement device for measuring the amount of voltage drop along the pipeline between the electrical contact assemblies.

Preferably, each of the electrical contact platform assemblies further includes: a carriage, a platform which is moveable radially outwardly and inwardly with respect to the carriage, and a contact cart which is moveable axially upon the platform between forward and rearward positions. The contact cart carries a conductive brush or prong or other conductive element.

In a described embodiment, one or more wheels are carried by the carriage of each electrical contact platform assembly. The wheels contact and roll along the interior surface of the surrounding pipe during use and, in turn, rotate one or more rotary cams which are also mounted on the carriage. In an exemplary embodiment, transmission gearing is used to transmit rotational movement of the wheels to the cams and impart a desired rotation rate to the cams.

Movement of the platform between radially inward and outward positions is preferably governed by a cam and follower system. Angular position of one or more rotary cams (typically a pair of rotary cams) will control the radial position of its associated platform. The platform is normally biased toward the radial inward position by springs. The rotary cams each feature an eccentric outer edge with a portion of increasing radius and a portion having a sharp reduction in radius. The outer edge of the cam contacts a follower portion of the platform and during rotation of the cam, the platform is moved radially outwardly as the portions of increasing radius urge the follower pins outwardly. When the follower pins encounter the reduction in radius, the platform is permitted to return to its radial inward position.

The contact cart is axially moveable upon the outer radial surface of the platform between forward and rearward positions upon the outer radial surface. In an exemplary described arrangement, the contact cart is mounted upon a guide bar and is moveable along the guide bar using rollers. In preferred embodiments, the contact cart is biased toward the forward position by a compression spring. Preferably also, the cart body presents an engagement pad which contacts and frictionally engages the interior surface of the pipe at the time that the conductive element does.

In operation, the pipe inspection tool is disposed into a surrounding pipe so that the wheels of each electrical contact platform assembly are in contact with the interior surface of the pipe. As the tool is moved axially through the pipe, rotation of the wheels will rotate the rotary cams of each electrical contact platform assembly. In a described embodiment, a gear box assembly provides a desired gear ratio to impart a desired rotation rate for the cams. Rotation of the cams will result in the platforms of each electrical contact platform assembly being moved radially outwardly and then radially inwardly. When the platforms are in their radially outward positions, a positive, stationary electrical contact is made between the contact carts of each electrical contact platform assembly and the interior surface. This positive, stationary contact is maintained with the pipe inner surface until the platforms are moved radially inwardly out of contact with the interior surface or until the cart moves into the jogged portion of the rail which moves it slightly radially inward despite the platform still being in a radially outward position. The rearward jogged portion of the rail is axially offset from the forward portion of the rail.

Stationary electrical contact is maintained over a period of time even as the tool continues to move through the pipe due to the ability of the contact carts to move axially with respect to their respective platforms. In particular, axial movement of the tool through the pipe allows the platform to slide with respect to the contact cart, which is engaged with the interior surface.

The invention also provides methods for measuring a voltage differential within a pipe wherein a voltage differential measurement tool is used that is axially moveable through the pipe. In accordance with these methods, a pair of conductive members are urged radially outwardly into stationary electrical contact with the pipe. The “pair” of conductive members would include a first conductive member from a forward electrical contact platform assembly and a second conductive member from a rearward electrical contact platform assembly. The pair of conductive members have a voltage differential applied between them across a section of the pipe over a distance of “d”. The pair conductive members are moved axially upon a portion of the voltage measurement tool in order to maintain the stationary electrical contact with the pipe for a period of time during which a voltage differential is applied and measured through the pair of conductive members.

An alternative aspect pipe inspection tool is described wherein the stationary contact platform assembly is at least one sensor platform assembly. The sensor platform assembly includes a platform which carries a sensor capable of measuring or detecting at least one pipe condition parameter, such as material hardness, acoustic, ultrasonic or other parameters. The sensor is preferably operably interconnected with a sensor processor and/or data storage. The sensor platform assembly features a carriage, a platform which is moveable radially outwardly and inwardly with respect to the carriage, and a sensor cart which is moveable axially upon the platform between forward and rearward positions. When the sensor cart is placed in stationary contact with the interior pipe wall, the sensor within the cart measures the pipe condition parameter.

The invention also provides methods for inspecting a pipe with a pipe inspection tool. In accordance with these methods, a pipe inspection tool is disposed within a pipe to be inspected. The pipe inspection tool has at least one stationary contact platform assembly (an electrical contact platform assembly or sensor platform assembly). Movement of the pipe inspection tool axially through the pipe causes the stationary contact platform assembly to move a platform radially outwardly to place a contact cart into stationary contact with the radial interior surface of the pipe. Stationary contact with the interior surface is maintained for a period of time while the pipe inspection tool continues to move axially through the pipe. Thereafter, axial movement of the pipe inspection tool through the pipe will cause the contact cart break contact with the interior surface. This process is repeated as the pipe inspection tool continues to move axially through the pipe.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side, cross-sectional view of an exemplary in-line pipeline inspection tool which incorporates electrical contact platform assemblies in accordance with the present invention.

FIG. 2 is an axial cross-section taken along lines 2-2 in FIG. 1.

FIG. 3 is an isometric view of a single exemplary electrical contact platform assembly.

FIG. 4 is an isometric view of the cart contact assembly of FIG. 3, now with the contact cart having been moved upon the platform.

FIG. 5 is a side, cross-sectional view of an exemplary electrical contact platform assembly with the platform in a radially retracted position.

FIG. 5A is a side view of the electrical contact platform assembly of FIG. 5.

FIG. 6 is a side, cross-sectional view of the electrical contact platform assembly of FIGS. 5 and 5A, now with the platform in a radially extended position.

FIG. 6A is a side view of the assembly of FIG. 6.

FIG. 7 is a side, cross-sectional view of the assembly of FIGS. 5, 5A, 6 and 6A with the platform in a radially extended position and moved axially with respect to the electrical contact.

FIG. 7A is a side view of the assembly of FIG. 7.

FIG. 8 is an enlarged isometric view illustrating portions of a contact cart in greater detail.

FIG. 9 is an enlarged side view of an exemplary rotary cam.

FIG. 10 is an isometric view of an alternative contact cart.

FIG. 11 is an isometric view of a further alternative contact cart.

FIG. 12 is an isometric view of a further alternative contact cart.

FIG. 13 is a cross-sectional view taken along lines 13-13 in FIG. 12.

FIG. 14 is a side view of a portion of an exemplary pipe inspection tool which incorporates a pipe condition sensor cart assembly.

FIG. 15 is an isometric view of an exemplary sensor cart.

### DETAILED DESCRIPTION OF THE PREFERRED EMBODIMENTS

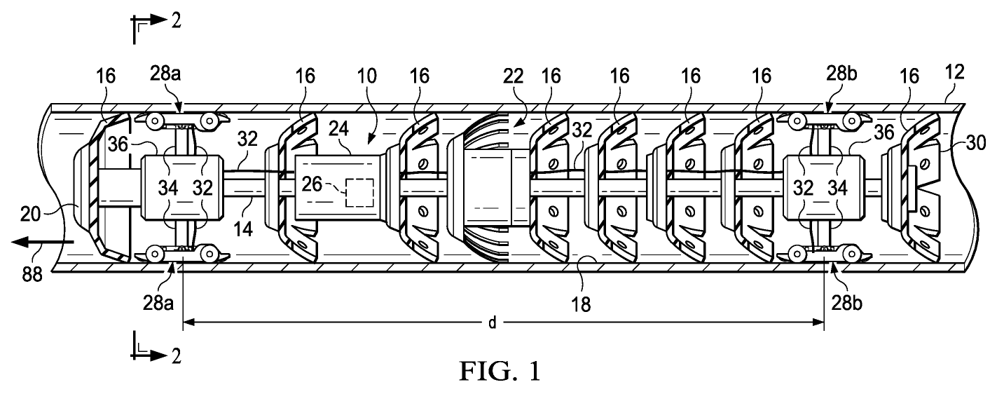

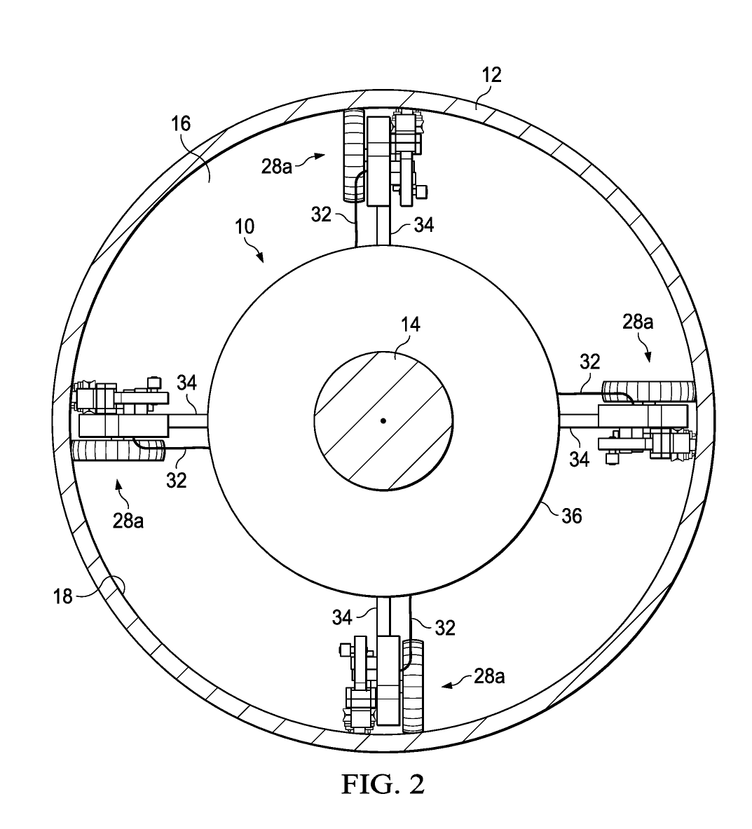

FIGS. 1 and 2 depict an exemplary in-line pipe inspection tool or device 10 which is disposed within a radially surrounding pipe 12 which may be a portion of a pipeline to be inspected. The tool 10 may also be referred to herein as a voltage differential measurement tool in view of its capacity to measure a voltage differential on a portion of the pipe 12. The tool 10 includes a central, elongated shaft assembly 14 which carries a plurality of shaped cups 16 for capturing fluid. The shaft assembly 14 may be of unitary construction but is more typically made up of a series of interconnected subs and shaft sections which are secured to one another in a sequential fashion. The shaft assembly 14 is maintained toward the center axis of the pipe 12 by cups 16 as the tool 10 is moved within the pipe 12.

The cups 16 are typically formed of polyurethane or another flexible material. During operation, the cups 16 typically contact the inner surface 18 of the surrounding pipe 12 and function to centralize the shaft assembly 14 within the pipe 12. In addition, the cups 16 are curved to capture pressurized fluid which helps move the tool 10 along the pipe 12. A generally conical nose cone 20 is located at the axial end of the central shaft assembly 14 and is the portion of the tool 10 which is inserted first into the pipe 12. The tool 10 carries a caliper section 22 which is used to detect deformation or alignment problems in a surrounding pipeline.

The tool 10 preferably includes a housing 24 which is mounted on or incorporated into the shaft assembly 14 and includes an electrical voltage measurement device 26, such as a voltmeter, to measure the voltage drop across a portion of the pipe 12. In particular, the voltage measurement device 26 measures the amount of voltage drop between electrical contact platform assemblies 28a, 28b. The measured voltage drop is then used to calculate the DC current and current density.

The tool 10 carries at least one, and preferably multiple, first and second electrical contact platform assemblies, generally shown at 28a, 28b, respectively. The tool 10 could carry at least one electrical contact platform assembly where differential measurements are not required. When the voltage differential is measured between the sets of electrical contact platform assemblies, the first electrical contact platform assemblies 28a are located at the forward axial end of the tool 10, proximate the nose cone 20. The second electrical contact platform assemblies 28b are located proximate the rear axial end 30 of the tool 10. It is noted that the first electrical contact platform assemblies 28a are located a spaced distance (“d”) from the second electrical contact platform assemblies 28b. Each electrical contact platform assembly 28a, 28b is designed to contact the interior surface 18 of the pipe 12 through which the tool 10 is moving and ensure communication of the voltage differential measured by electric contacts of the contact platform assemblies 28a, 28b to the pipe surface 18. Electrical wiring 32 interconnects the voltage measurement device 26 with the electrical contact platform assemblies 28a, 28b. Because the electrical contact platform assemblies 28a, 28b are located a known, set distance (“d”) from one another, a drop in voltage between the two assemblies through the pipe surface 18 can be measured by the voltage measurement device 26.

Each electrical contact platform assembly 28a, 28b is connected by a support arm 34 to a central hub 36 which is incorporated into the central shaft assembly 14. Multiple support arms 34, which extend radially outwardly from the hub 36 in multiple radial directions, are preferred to support the shaft assembly 14 regardless of the angular orientation of the tool 10 within the pipe 12.

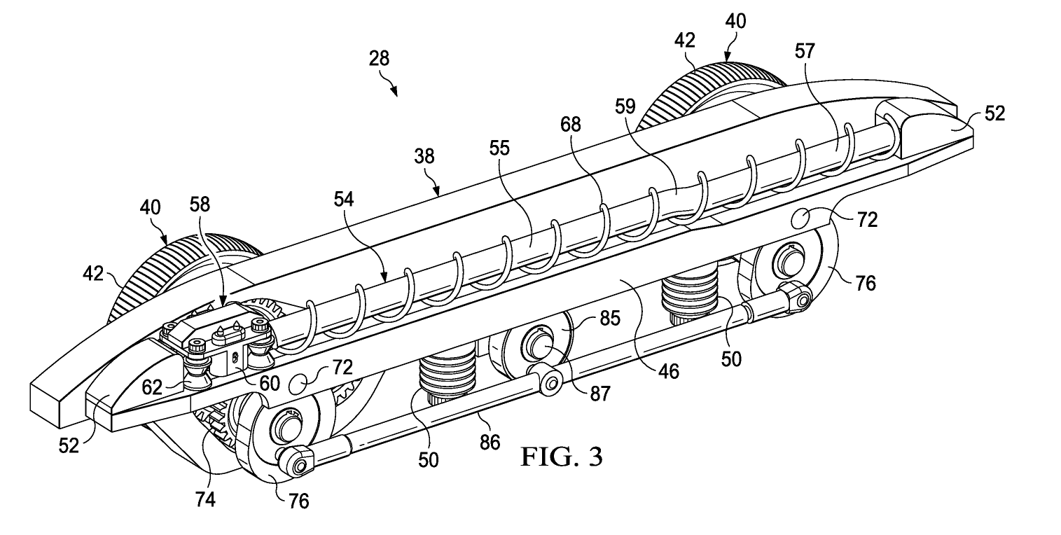

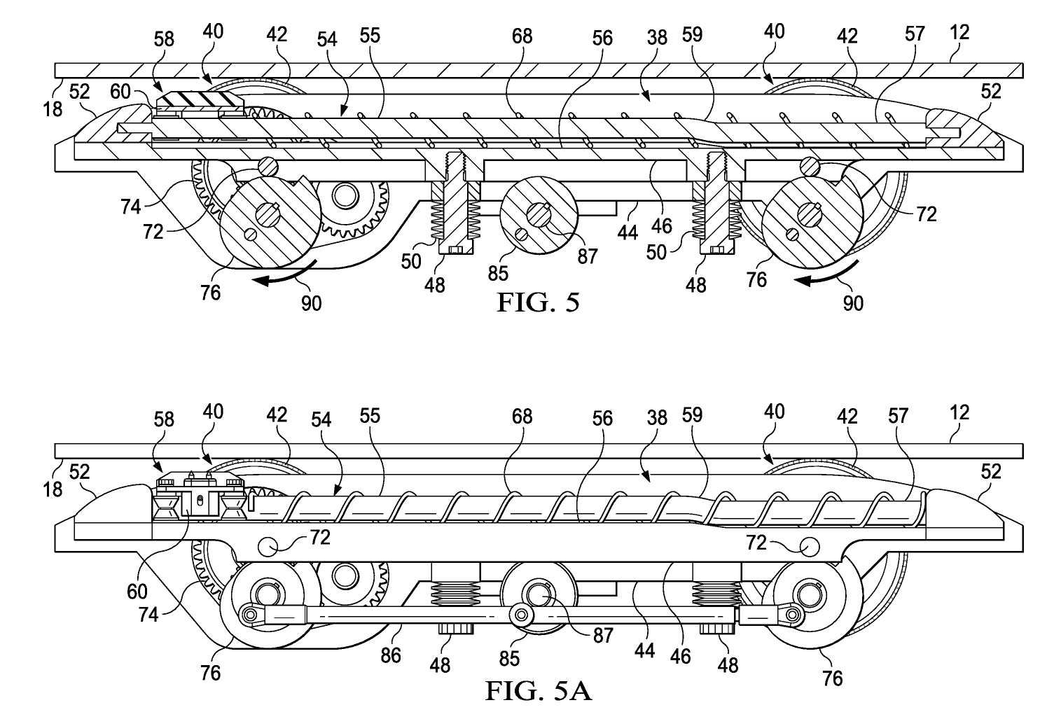

An exemplary electrical contact platform assembly 28 is illustrated in FIGS. 3-7 apart from other components of the tool 10 and is representative of at least one or of all of the first and second electrical contact platform assemblies 28a and 28b. The electrical contact platform assembly 28 includes an elongated carriage 38 which largely carries or supports the other components of the electrical contact platform assembly 28. Carriage 38 is directly supported by the support arm 34. The carriage 38 carries front and rear wheels 40, each of which are rotationally mounted upon an axis (not shown). Wheels 40 each present a radially outer contact surface 42 which contact and roll along the interior surface 18 of the pipe 12. The wheels 40 are preferably not electrically conductive. The outer contact surface 42 of the wheels 40 is preferably a traction surface (roughened or knurled) to minimize slip upon the pipe 12 during operation. The carriage 38 does not contact the interior surface 18 of the pipe 12 during use, as is apparent from FIGS. 5-7. A platform support 44, best seen in FIGS. 5-7, extends laterally outwardly from the carriage 38.

An elongated platform 46 is disposed alongside the carriage 38 and atop the platform support 44. The platform 46 is secured to the platform support 44 by a pair of retaining bolts 48. A compression spring 50 radially surrounds the shaft of each retaining bolt 48 and biases the platform 46 radially inwardly onto the platform support 44. Compression spring 50 may be in the form of stacked washers.

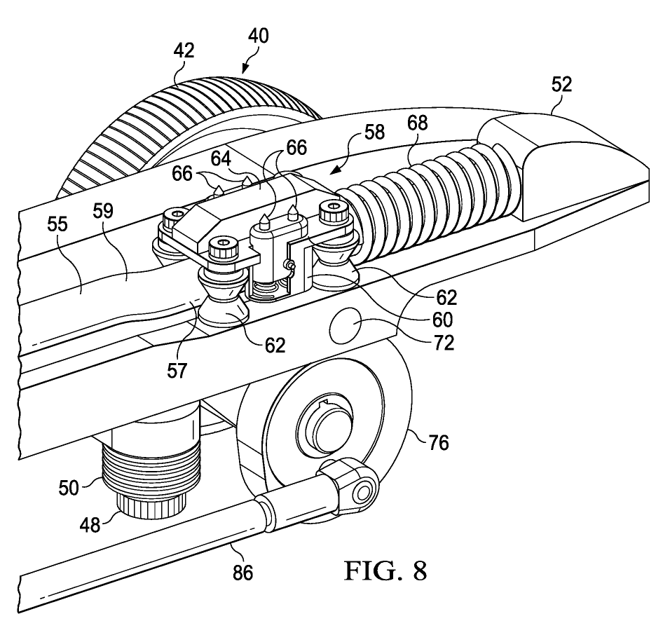

Brackets 52 secure a guide bar 54 above the outer radial surface 56 of the platform 46. A contact cart, generally shown at 58, is mounted upon the guide bar 54. Features of the contact cart 58 are shown in greater detail in FIG. 8. As seen there, the contact cart 58 includes a cart body 60 having rollers 62 which contact and roll along the guide bar 54. Preferably, the guide bar 54 has a forward portion 55 and a rearward portion 57. A jog 59, or lateral shift in the axis of the guide bar 54, interconnects the forward portion 55 and rearward portion 57.

An engagement pad 64 protrudes radially upwardly from the cart body 60. The engagement pad 64 may be made of electrically conductive material so as to itself form electrical contact with the interior wall upon engagement. Alternatively, the engagement pad 64 can be made of a non-conductive material and function only to engage the interior surface 18 in a gripping manner. One or more electrically conductive elements 66 also extend radially outwardly from the cart body 60. Preferably, the conductive elements 66 are prongs or brushes made of electrically conductive material, such as steel. However, the conductive elements 66 may take other forms. The conductive elements 66 are in electrical communication with the voltage measurement device 26 so that a voltage potential can be measured across sections of the pipe 12. As best appreciated with reference to FIGS. 3-4 and 5-7, a compression spring 68 biases each contact cart 58 axially toward the forward axial end 70 of the guide bar 54 (see FIGS. 3, 5).

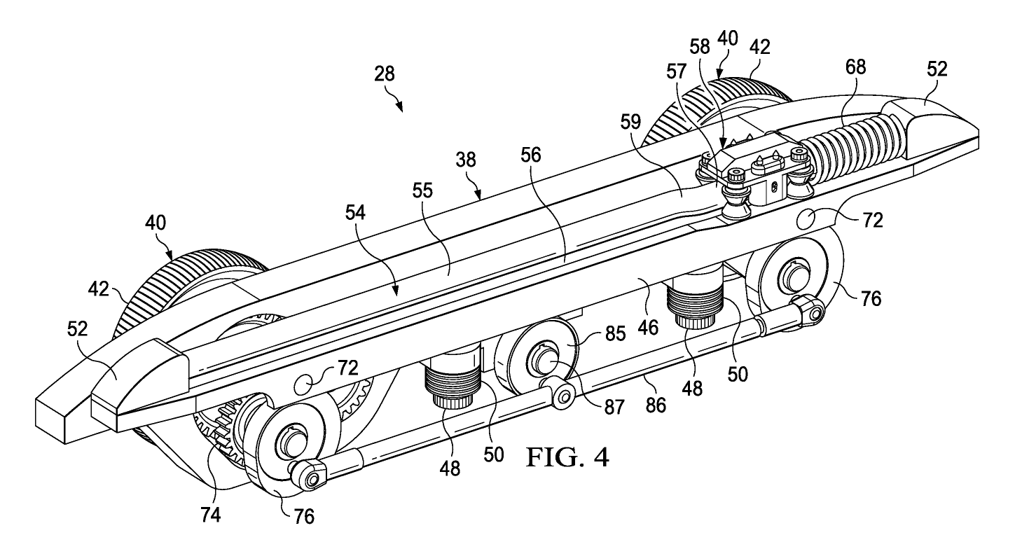

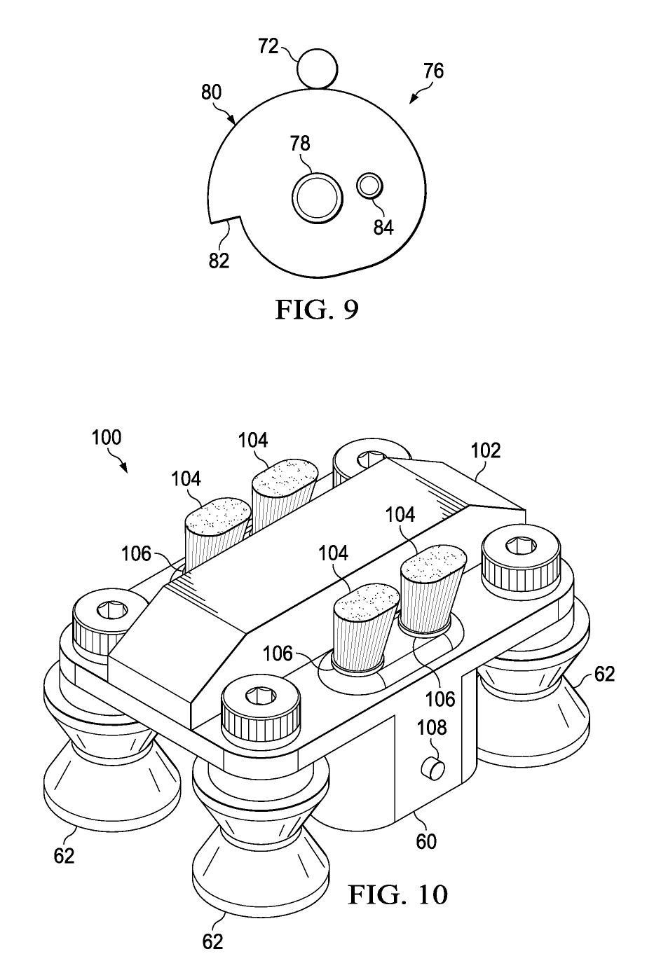

The platform 46 is moved radially outwardly and inwardly, with respect to the carriage 38 using a cam and follower system. Follower pins 72 are secured to the interior radial surface of the platform 46. Transmission gears 74 transfer rotational power from each wheel 40 to a rotary cam 76. The transmission gears 74 provide a desired gear ratio to impart the desired speed of rotation rate of the rotary cams 76. As best shown in FIG. 9, each cam 76 rotates about central axle 78 and presents an eccentric outer edge 80 such that there is a gradual increase in radius of the cam 76 proceeding counterclockwise around the outer edge 80 followed by a sharp reduction 82 in radius. An offset axle 84 is preferably provided within the cam 76. Preferably, the cams 76 are interconnected with a coupling shaft 86 so that the cams 76 rotate together, as illustrated in FIGS. 3-4. The axial ends of the coupling shaft 86 are affixed to the offset axles 84 of each cam 76. Preferably, the coupling shaft 86 is secured to central wheel 85. The central wheel 85 rotates about hub 87. The central wheel 85 help stabilize and align the coupling shaft 86 during operation.

FIGS. 10-14 depict alternative constructions for a contact cart which could be substituted for contact cart 58. FIG. 10 shows a contact cart 100 which includes cart body 60 and rollers 62. A non-conductive engagement pad 102 is mounted upon the cart body 60. Conductive pencil brush contacts 104 extend upwardly (toward the interior pipe surface 18) from the cart body 60. Pencil brush contacts 104 are preferably bundles of conductive wire bristles which are crimped together at their base by a thin shell 106. The pencil brush contacts 104 are potted within the cart body 60 and are connected to an internal circuit (not shown) having an output conductor 108 through which electrical connection is made with the electrical source 24 and electrical voltage measurement device 26. Preferably, the distal ends of the pencil brush contacts 104 extend upwardly beyond the upper surface of the engagement pad 102 but are able to buckle and deform elastically so that, when the engagement pad 102 is in contact with the interior surface 18, the pencil brush contacts 104 will also be in conductive contact with the surface 18.

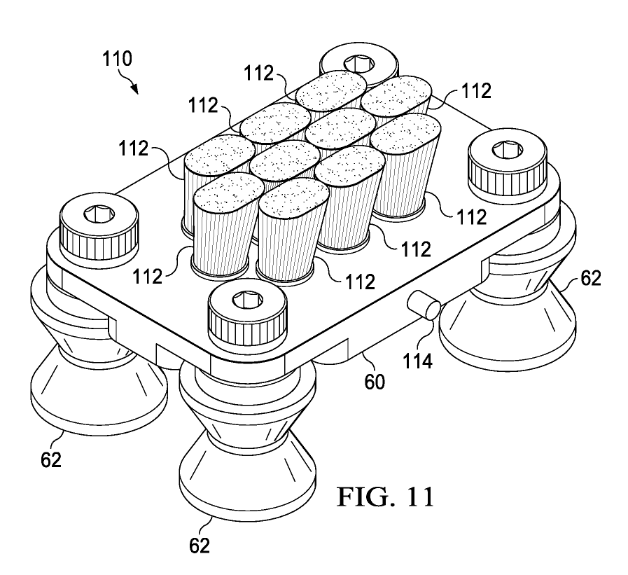

FIG. 11 depicts an exemplary contact cart 110 in which there is no engagement pad. Pencil brush contacts 112 extend upwardly from the cart body 60 and, when brought into contact with the interior surface 18, will themselves grip the surface 18 while providing electrical conduction. An output conductor 114 is provided through which electrical connection with the pencil brush contacts 112 is made.

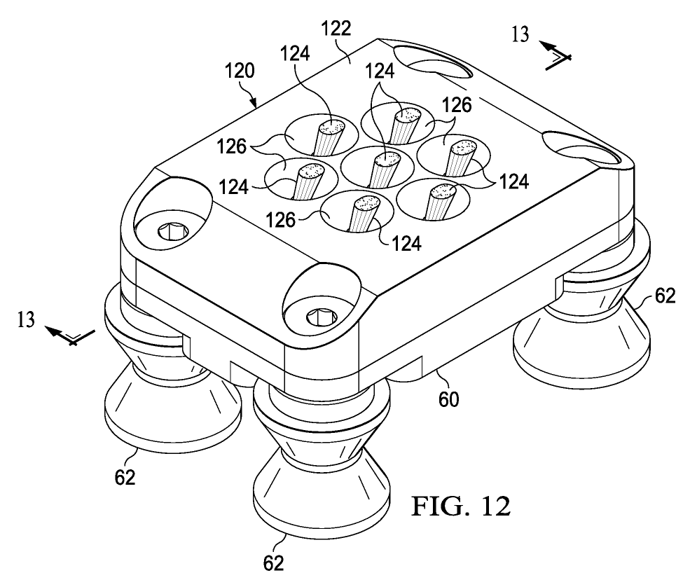

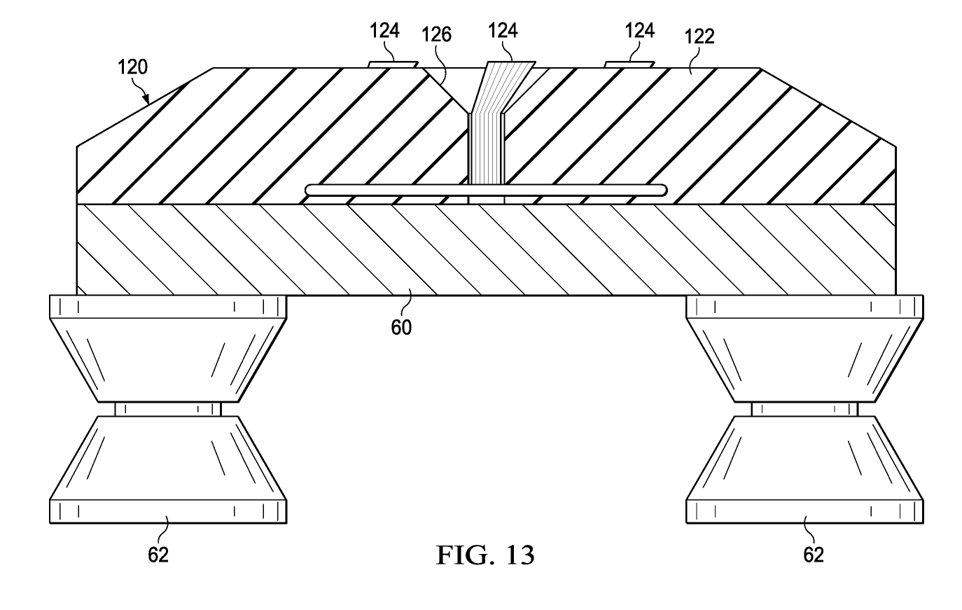

FIGS. 12-13 illustrate a further alternative contact cart 120 wherein an engagement pad 122 is mounted upon the cart body 60 and contains embedded pencil brush contacts 124. Engagement pad 122 may be formed of machined metal, and the pencil brush contacts 124 may be embedded by brazing or by interference fit. Alternatively, the engagement pad 122 may be formed of polyurethane or epoxy and the pencil brush contacts 124 potted therein. As can be seen from FIG. 13, the pencil brush contacts 124 protrude above the engagement pad 122. Preferably, a conical countersink 126 surrounds each of the pencil brush contacts 124 and functions to permit deformation of the pencil brush contacts 124 when the engagement pad 122 and contacts 124 are brought into contact with the interior surface 18 of the pipe 12.

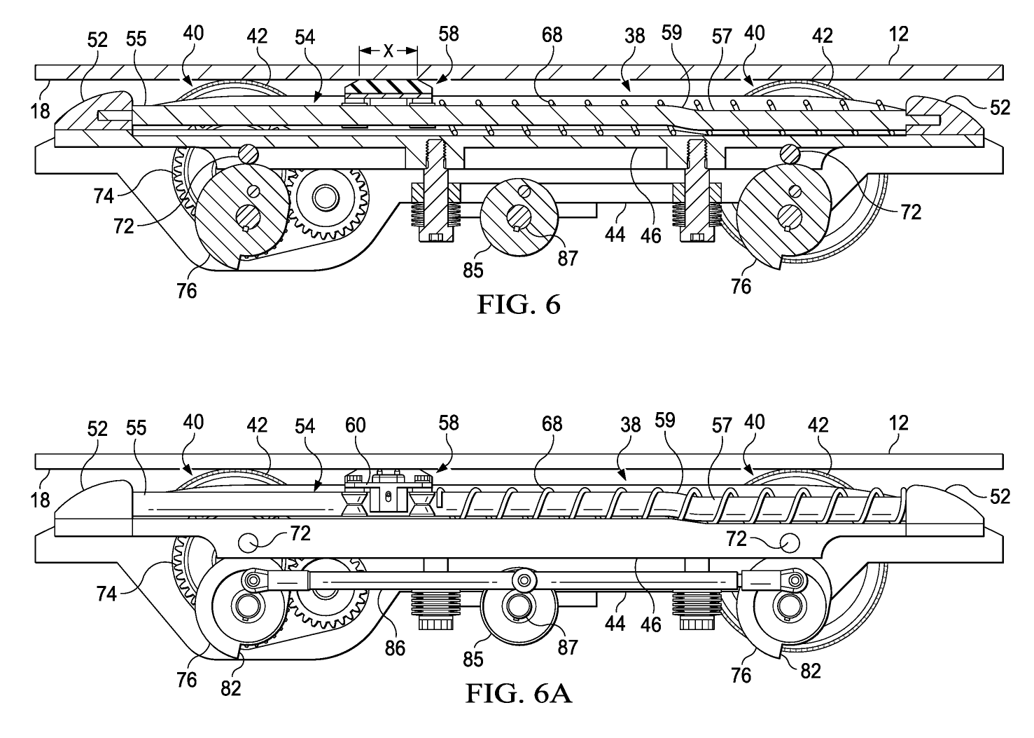

In operation, the tool 10 is disposed into a pipe or pipeline 12, as depicted in FIG. 1. Pressurized fluids, which are captured by the cups 16, move the tool 10 axially along the pipe 12 in the direction of arrow 88 in FIG. 1. The wheels 40 of each electrical contact platform assembly 28 will contact and roll along the interior surface 18 of the pipe 12 during this time. Rotational energy from rotation of the wheels 40 will be transmitted via gears 74 to rotate the cams 76 in a clockwise direction as illustrated by arrows 90 in FIG. 5. Rotation of the cams 76 will urge the follower pins 72 and affixed platform 46 radially outwardly (see FIGS. 5-6) as the follower pins 72 encounter the increasing radius outer edges 80 of the cams 76. In the radially outward position shown in FIG. 6, the engagement pad 64 and conductive elements 66 of each contact cart 58 are brought into contact with the interior surface 18 of the pipe 12, and the engagement pad 64 frictionally engages the interior surface 18. In particular, the engagement and stationary contact occurs at “x” shown in FIG. 6.

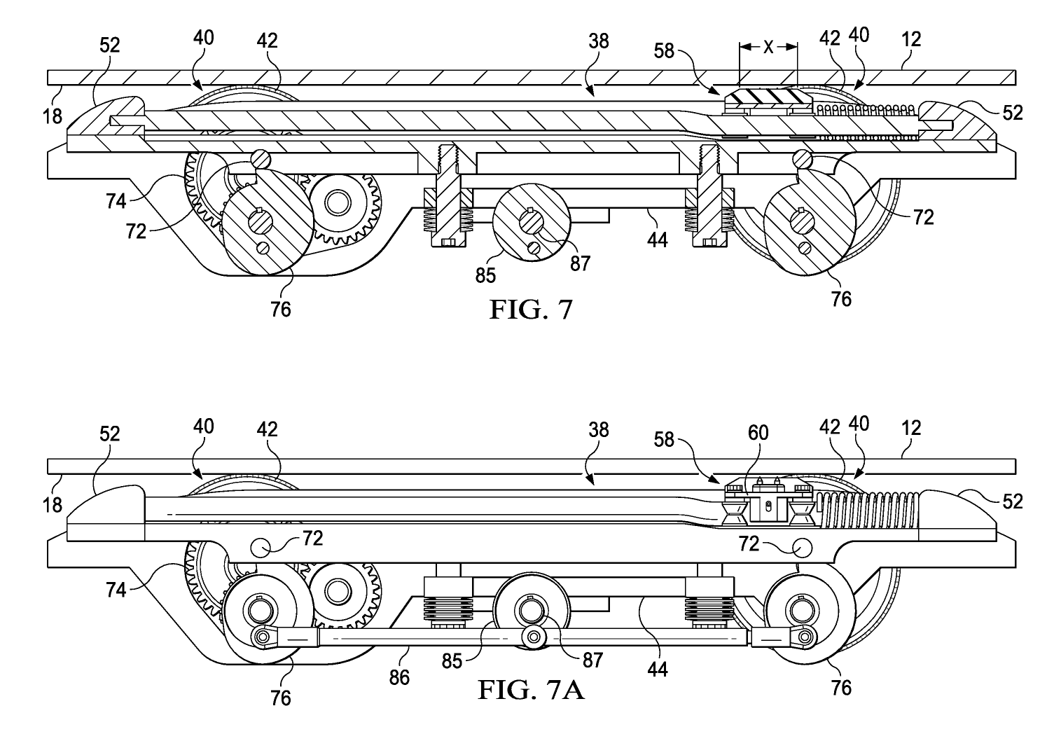

The cams 76 continue to urge the engagement pads 64 and brushes/prongs 66 into contact with the interior surface 18 as the tool 10 continues moving axially along the pipe 12. Further movement of the tool 10 axially along the pipe 12 will cause the contact cart 58 of each electrical contact platform assembly 28 to be moved axially along the guide bar 54 of the platform 46 due to the frictional engagement between the engagement pad 64 and the interior surface 18. The contact cart 58 is then moved to a rearward position, which is depicted in FIGS. 4 and 7. However, stationary contact due to frictional engagement at “x” is maintained, as shown in FIG. 7. The compression spring 68 is axially compressed.

Still further axial movement of the tool 10 through the pipe 12 will next retract the platforms 46 to the radially retracted position illustrated in FIG. 5. The cams 76 will rotate until the follower pins 72 encounter and pass the radial reduction 82 of their respective cams 76, allowing the springs 50 to then return the platform 46 radially inwardly. Alternatively, the contact cart 58 will encounter the jog 59 in the guide rail 54 and move onto the rearward portion 57 of the guide rail 54 (see FIG. 7). Because the axis of the rearward portion 57 is further away from the pipe 12 than the axis of the forward portion 55, the contact cart 58 is moved slightly radially inwardly and away from the interior surface 18. Once the engagement pads 64 are released from the interior surface 18 of the pipe 12, the compression springs 68 will also return the contact carts 58 to their initial forward positions upon the guide bars 54.

It should be understood that the features of a platform 46 which can be moved radially outwardly and then inwardly and a contact cart 58 which can move axially upon the platform 46 allows the electrical contact platform assembly 28 to retain an electrically conductive element 66 in positive, stationary contact with the interior surface of the pipe 12 for a period of time to ensure a period of no loss of transmission. The contact is considered to be stationary because the conductive element 66 is maintained in contact with a point on the interior surface 18 for a period of time without being moved along or slid along the interior surface 18. The positive, stationary contact occurs even as the tool 10 itself is moved axially along the pipe 12. In particular, the positive, stationary contact is maintained from the time the conductive elements 66 are first brought into contact with the interior surface 18 (FIG. 6) until the conductive elements 66 are moved to their rearmost position upon the guide bars 54 (FIG. 7) and then released from contact with the interior surface 18. The positive, stationary contact accorded by the features of the present invention allow for an increased period of time for measurements to be made as compared to conventional brushes and knives which provide a sliding and perhaps intermittent contact as the tool 10 is moved through the pipeline.

The invention provides methods for measuring a voltage differential within a portion of a pipe 12. In accordance with described methods, a voltage differential measurement device, such as tool 10 having at least one electrical contact platform assembly 28 is disposed into the pipe 12, and the tool 10 moves axially through the pipe 12 under the impetus of fluid flowing through the pipe 12. A platform 46 mounted upon the electrical contact platform assembly 28 is moved radially outwardly to cause a stationary electrical contact between a conductive member 66 on the electrical contact platform assembly 28 and an interior surface 18 of the pipe 12 which is useful for measuring a voltage differential within a portion of pipe 12. Next, stationary electrical contact is maintained between the conductive member 66 and the interior surface 18 as the tool 10 moves axially further through the pipe 12. Thereafter, the platform 46 is moved to a radially inward position, thereby breaking the stationary electrical contact. In accordance with described methods, stationary electrical contact is maintained while the tool 10 moves axially through the pipe 12 by moving the conductive member 66 axially along a longitudinal platform 46 of the electrical contact platform assembly 28 from an axially forward position to an axially rearward position. During this time, the voltage differential is applied and measured via the stationary electrical contact.

The present invention also provides methods for measuring a voltage differential within a pipe 12 in which a voltage differential measurement tool 10 is used. In accordance with these methods, a pair of conductive members 66 are urged radially outwardly into stationary electrical contact with the pipe 12. The “pair” of conductive to members 66 would include a first conductive member 66 from the forward electrical contact platform assembly 28a and a second conductive member 66 from the rearward electrical contact platform assembly 28b. The pair of conductive members 66 have a voltage differential applied between them across a section of pipe 12 over a distance of “d”. The pair conductive members 66 are moved axially upon a portion of the tool 10 in order to maintain the stationary electrical contact with the pipe 12 for a period of time during which a voltage differential is applied and measured through the pair of conductive members 66.

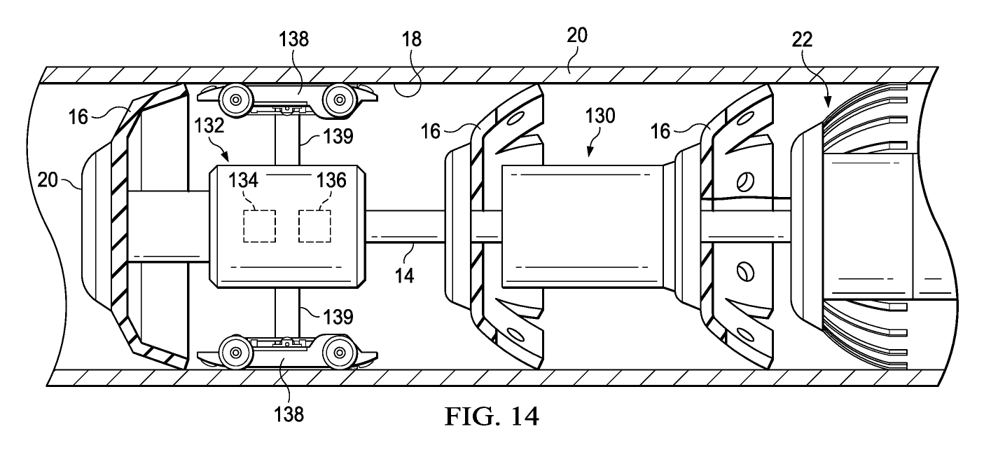

In other aspects, the invention provides devices and methods for bringing other varieties of sensors used with pipe inspection tools into contact with the surrounding pipe. FIG. 14 illustrates an exemplary pipe inspection tool 130 which is constructed and operates in the same manner as inspection tool 10 except where otherwise described here. The pipe inspection tool 130 includes a pipe sensor assembly, generally indicated at 132 which functions to sense or detect one or more pipe condition parameters, such as material hardness, acoustic, ultrasonic or other properties. The pipe sensor assembly 132 includes sensor data memory storage 134 and a power supply 136 which provides power to the memory storage 134 and any sensors within the pipe sensor assembly 132. The pipe sensor assembly 132 also includes at least one sensor platform assembly 138 which extends radially outwardly from the shaft assembly 14 by at least one support arm 139.

The sensor platform assembly 138 features a carriage, a platform which is moveable radially outwardly and inwardly with respect to the carriage, and a sensor cart which is moveable axially upon the platform between forward and rearward positions. Except where otherwise described, the sensor platform assembly 138 may have the same structure and operate in the same manner as the electrical contact platform assemblies 28 described previously. The sensor platform assemblies 138 are also operated using wheels, gear box and cams as previously described.

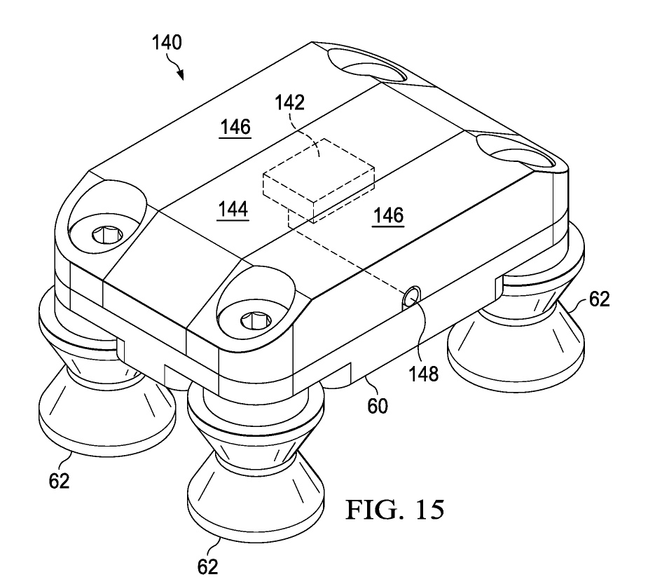

FIG. 15 depicts an exemplary sensor cart 140 which would be used with the sensor platform assembly 138 in place of a contact cart 58, 100, 110 or 120. The sensor cart 140 contains a sensor 142. Sensor 142 is a contactless or proximity sensor which can sense temperature, pressure or magnetic properties of the pipe 12. The sensor 142 may also be an acoustic emission sensor, ultrasonic transducer, material hardness tester, eddy coil, Hall effect or other sensor known in the art. The sensor 142 is retained within a sensor molding 144 which is located between two engagement blocks 146. Preferably, the sensor molding 144 is spring-biased upwardly from the cart body 60 in order to assure positive contact is made between the sensor molding 144 and the interior surface 18 of the pipe 12. The spring mounting will also permit the sensor molding 144 to be pushed below the level of the engagement blocks 146 which will protect it from compressive loads. An electrical connection 148 is provided on the side of the sensor cart 140 by which the sensor 142 can be interconnected with the memory storage 134 and power supply 136.

Electrical contact with the interior pipe surface 18 is not necessary for the sensor 142 so it would not be necessary for there to be a forward and rearward pair of sensor platform assemblies 138. In accordance with other embodiments, the sensor cart 142 may be provided with a penetrative probe which is capable of penetrating the interior surface 18 of the pipe 12.

It should be understood that the invention generally provides a pipe inspection tool 10 or 110 which is useful for measuring or detecting at least one pipe condition parameter for a pipe 12. The pipe inspection tool 10 or 110 includes at least one stationary contact platform assembly which may be either an electrical contact platform assembly 28 or a sensor platform assembly 138. The stationary contact platform assembly includes a platform 46 which is moved radially outwardly as the pipe inspection tool 10 or 110 is moved axially through the pipe 12. Radial outward movement of the platform 46 will bring a contact cart into stationary contact with the interior surface 18 of the pipe 12. The contact cart may be either an electrical contact cart 58, 100, 110 or 120 or a sensor cart 140 which is capable of detecting at least one pipe condition parameter for the surrounding pipe 12.

It should be understood that the invention provides a general method of pipe inspection wherein a pipe inspection tool 10 or 110 having at least one stationary contact platform assembly (electrical contact platform assembly 28 or sensor platform assembly 138) is disposed within a pipe 12 to be inspected. Movement of the pipe inspection tool 10 or 110 axially through the pipe 12 will cause the electrical contact platform assembly 28 or sensor platform assembly 138 to move a platform 46 radially outwardly to place a contact cart (electrical contact cart 58, 100, 110 or 120 or sensor cart 140) into stationary contact with the radially interior surface 18 of the pipe 12. Stationary contact with the interior surface 18 is maintained for a period of time while the pipe inspection tool 10 or 110 continues to move axially through the pipe 12. It should be noted that the stationary positioning of the probe or sensor over the pipe surface 18 is achieved by maintaining equal linear speed of the contact cart and tool speed in opposite direction of one to another. Thereafter, axial movement of the pipe inspection tool 10 or 110 through the pipe 12 will cause the electrical contact cart 58, 100, 110 or 120 or sensor cart 140 to break contact with the interior surface 18. This process is repeated as the pipe inspection tool 10 or 110 continues to move axially through the pipe 12.

What is claimed is:

1. A pipe inspection tool comprising:
a central shaft assembly to be inserted into and move axially through a pipe;
a stationary contact platform assembly which extends radially outwardly from the central shaft, the stationary contact platform assembly including:
a platform which is moveable between a radially inward and a radially outward position; and
a contact cart carried by the platform and placed into stationary contact with an interior surface of the pipe when the platform is in the radially outward position, the contact cart detecting at least one pipe condition parameter during stationary contact.

2. The pipe inspection tool of claim 1 wherein:
the contact cart is mounted upon the platform for movement between an axially forward position and an axially rearward position; and
the contact cart is moved from the axially forward position to the rearward position when the contact cart is in contact with the interior surface of the pipe during movement of the device through the pipe.

3. The pipe inspection tool of claim 1 wherein the platform is moved between the radially inward and radially outward positions by rotation of a rotary cam having an irregular outer edge.

4. The pipe inspection tool of claim 1 further comprising:
a carriage which supports the platform, the platform being moveable radially inwardly and outwardly with respect to the carriage;
a wheel which is carried by the carriage, the wheel being in contact with and rolling along the interior surface of the pipe as the device is moved through the pipe;
a rotary cam which is rotated by rotation of the wheel; and
rotation of the rotary cam governing movement of the platform between its radially inward and radially outward positions.

5. The pipe inspection tool of claim 2 wherein the contact cart is mounted upon the platform by slidable movement upon a guide bar secured above an outer radial surface of the platform.

6. The pipe inspection tool of claim 1 wherein the contact cart carries a conductive member formed of electrically conductive material.

7. The pipe inspection tool of claim 5 wherein the contact cart is biased toward the axially forward position by a compression spring.

8. The pipe inspection tool of claim 1 wherein the pipe condition parameter being detected is voltage differential, and wherein:
the stationary contact platform assembly comprises first and second electrical contact platform assemblies to make electrical contact with the pipe so that a voltage differential can be measured between the first and second electrical contact platform assemblies.

9. The pipe inspection tool of claim 1 further comprising a plurality of shaped cups for capturing fluid, the cups extending radially outwardly from the shaft assembly.

10. The pipe inspection tool of claim 1 wherein each of the stationary contact platform assemblies further comprises:
a wheel which contacts and rolls along the pipe as the shaft assembly moves axially through the pipe; and
a rotary cam which is rotated by the wheel, the rotary cam governing movement of the platform between the radial inward and radial outward positions.

11. The pipe inspection tool of claim 10 further comprising a transmission gear for transmitting rotary movement of the wheel into rotational energy to rotate the rotary cam.

12. The pipe inspection tool of claim 1 wherein the contact cart comprises a sensor cart which carries a sensor which is capable of detecting material hardness, acoustic or ultrasonic properties of the pipe.

13. A pipe inspection tool comprising:
a central shaft assembly to be inserted into and move axially through a pipe;
at least one shaped cup for capturing fluid extending radially outwardly from the shaft assembly;
a stationary contact platform assembly which extends radially outwardly from the central shaft, the stationary contact platform assembly including:
a platform which is moveable between a radially inward and a radially outward position; and
a contact cart carried by the platform and placed into stationary contact with an interior surface of the pipe when the platform is in the radially outward position, the contact cart detecting at least one pipe condition parameter during stationary contact.

14. The pipe inspection tool of claim 13 wherein:
the contact cart is mounted upon the platform for movement between an axially forward position and an axially rearward position; and
the contact cart is moved from the axially forward position to the rearward position when the contact cart is in contact with the interior surface of the pipe during movement of the device through the pipe.

15. The pipe inspection tool of claim 13 wherein the platform is moved between the radially inward and radially outward positions by rotation of a rotary cam having an irregular outer edge.

16. The pipe inspection tool of claim 13 further comprising:
a carriage which supports the platform, the platform being moveable radially inwardly and outwardly with respect to the carriage;
a wheel which is carried by the carriage, the wheel being in contact with and rolling along the interior surface of the pipe as the device is moved through the pipe;
a rotary cam which is rotated by rotation of the wheel; and
rotation of the rotary cam governing movement of the platform between its radially inward and radially outward positions.

17. A method of inspecting a pipe to detect at least one pipe condition parameter, the method comprising:
disposing a pipe inspection tool within a pipe to be inspected, the pipe inspection tool having at least one stationary contact platform assembly;
axially moving the pipe inspection tool within the pipe to cause the stationary contact platform assembly to move a platform radially outwardly to place a contact cart into stationary contact with a radial interior surface of the pipe; and
maintaining stationary contact with the interior surface for a period of time while the pipe inspection tool continues to move axially through the pipe.

18. The method of claim 17 further comprising the step of breaking contact between the contact cart and the interior surface after the period of time.

19. The method of claim 17 wherein the step of maintaining the stationary contact with the interior surface further comprises moving the contact cart axially along a radially outer surface of the platform.
